(19) United States
(12) Patent Application Publication
(10) Pub. No.: US 2022/0237347 A1
(43) Pub. Date: Jul. 28, 2022

(54) Training Wave-Based Physical Systems as Recurrent Neural Networks

(71) Applicant: The Board of Trustees of the Leland Stanford Junior University, Stanford, CA (US)

(72) Inventors: Tyler William Hughes, San Diego, CA (US); Ian A.D. Williamson, Mountain View, CA (US); Momchil Minkov, San Mateo, CA (US); Shanhui Fan, Stanford, CA (US)

(21) Appl. No.: 16/852,511

(22) Filed: Apr. 19, 2020

Related U.S. Application Data
(60) Provisional application No. 62/836,328, filed on Apr. 19, 2019.

(51) Int. Cl. G06F 30/27; G06N 3/04; G06N 3/063

(52) U.S. Cl. CPC G06F 30/27; G06N 3/0635; G06N 3/0445

(57) ABSTRACT

A method is disclosed for designing an analog computer that implements a trained recurrent neural network. A computer simulates a wave-based physical system including a wave propagation domain, a boundary layer that approximates a boundary condition, a source of waves, probes for measuring properties of propagated waves, a material within a central region of the wave propagation domain. The simulation also includes a discretized numerical model of a differential equation describing dynamics of wave propagation in the physical system. The simulation is trained with sequential training data by inputing samples of the training data at the source in batches, computing for each batch measured properties of propagated waves at the probes, evaluating for each batch a loss function between the measured properties of propagated waves at the probes and correct classification, and minimizing the loss function with respect to physical characteristics of the material within a central region of the simulation domain using gradient-based optimization.

### CROSS-REFERENCE TO RELATED APPLICATIONS

This application claims priority from U.S. Provisional Patent Application 62/836,328 filed Apr. 19, 2019, which is incorporated herein by reference.

### STATEMENT REGARDING FEDERALLY SPONSORED RESEARCH OR DEVELOPMENT

This invention was made with Government support under contract FA9550-17-1-0002 awarded by the United States Air Force, and under contract N00014-17-1-3030 awarded by the Department of Defense. The Government has certain rights in the invention.

### FIELD OF THE INVENTION

The present invention relates generally to analog computers. More specifically, it relates to techniques for designing analog computers that implement machine learning computations.

### BACKGROUND OF THE INVENTION

Recently, machine learning has had notable success in performing complex information processing tasks, such as computer vision and machine translation, which were intractable through traditional methods. However, the computing requirements of these applications is increasing exponentially, motivating efforts to develop new, specialized hardware platforms for fast and efficient execution of machine learning models.

Analog computing is one attractive approach to novel machine learning hardware, wherein the computation is performed by naturally evolving a physical system. Analog machine learning hardware platforms could potentially be faster and more energy-efficient than their digital counterparts. However, the realization of analog computer implementation of machine learning has thus far proved elusive because (1) one must identify a physical system capable of performing the necessary computation, and (2) one must be able to train the physical system on a given machine learning task.

### BRIEF SUMMARY OF THE INVENTION

The inventors have identified a formal correspondence between the dynamics of wave-based physical systems and the computation in recurrent neural networks (RNNs) and ex-ploited this correspondence to develop techniques for the design of analog computing platforms that implement RNNs. Using a simulation of a physical wave system, physical parameters of the system are trained to learn complex features in temporal data, using training techniques for neural networks. The physical system simulation is trained on a machine learning task using inverse design techniques, which optimize the physical characteristics of the system in the context of numerical simulations.

The dynamic evolution of waves in the trained physical system implements an analog computation of an RNN on the temporal data. RNNs are one of the most important machine learning models and have been widely used to perform tasks such as natural language processing and time-series prediction, which involve processing of sequential data.

A wave-based physical system constructed according to the trained design can passively process signals and information in their native domain, without analog-to-digital conversion. Compared to conventional digital-computer implemented RNNs, such an analog computer implemented RNN has an improved processing speed, energy efficiency, and compactness. Furthermore, the approach is general to wave-based physical systems, so that the physical system implementing the RNN may be realized in physical systems supporting optical, acoustic, hydraulic, or geophysical wave propagation.

Applications of these analog computer implemented RNNs can be envisioned as hardware with improved computational performance on machine learning problems involving sequential data. Some examples including: time-series prediction and classification, natural language processing, machine translation, speech recognition, genetic sequence analysis. Generality of the approach leads to applications in wide range of fields, from optics, audio/acoustics, medicine, biology, finance, and speech recognition.

Embodiments of this invention can be deployed as methods, computer algorithms or code, hardware processors executing programmable language, algorithms or code, as well as system incorporating such methods, algorithms, code, processors, or the like.

Embodiments of the invention have advantages over prior approaches to analog computing for machine learning, such as reservoir computing, as these prior approaches do not provide an ability to train the physical system, which is crucial for implementing models, such as RNNs. The approach of this invention uses inverse design techniques during numerical modeling to design the physical system, e.g., its material patterning, which can be realized using 3D printing, photolithography, and other fabrication techniques. Furthermore, this approach provides analog computational implementation of an RNN, which is a specific and complicated model for handling sequential data.

In one aspect, the invention provides a method of designing an analog computer that implements a trained recurrent neural network, the method comprising: simulating a wave-based physical system using a computational simulation, wherein the computational simulation comprises: a wave propagation domain, a boundary layer that approximates a boundary condition, a source of waves, probes for measuring properties of propagated waves, a material within a central region of the wave propagation domain, and a discretized numerical model of a differential equation describing dynamics of wave propagation in the physical system; training the simulation with sequential training data, wherein the training comprises: inputing samples of the training data at the source in batches, computing for each batch measured properties of propagated waves at the probes, evaluating for each batch a loss function between the measured properties of propagated waves at the probes and correct classification, and minimizing the loss function with respect to physical characteristics of the material within a central region of the simulation domain using gradient-based optimization.

The physical characteristics may comprise a material density distribution of the material within a central region of the simulation domain. The simulating may comprise a low-pass spatial filtering applied to a wave speed distribution to implement training regularization. The simulating and training may be implemented using a machine learning computing platform.

The wave-based physical system may be an acoustic, hydraulic, or optical system. The boundary layer may be an absorbing boundary layer and the boundary condition is an open boundary condition. Alternatively, the boundary layer may be a reflecting boundary layer and the boundary condition is a closed boundary condition. The probes for measuring properties of propagated waves may be point probes or spatially extended probes. The measured properties of propagated waves may comprise time-integrated power or field amplitude.

### BRIEF DESCRIPTION OF THE SEVERAL VIEWS OF THE DRAWINGS

FIG. 1A is a diagram of a recurrent neural network (RNN) cell operating on a discrete input sequence and producing a discrete output sequence.

FIG. 1B is a diagram showing internal components of the RNN cell of FIG. 1A.

FIG. 1C is a directed graph illustrating a sequence of actions of the RNN cell of FIG. 1B on an input data sequence to produce an output data sequence.

FIG. 1D is a diagram of a recurrent representation of a continuous physical system operating on a continuous input signal and producing a continuous output signal.

FIG. 1E is a diagram showing internal components of a discretized recurrence relation for a wave equation describing the dynamics of the continuous system of FIG. 1D.

FIG. 1F is a directed graph of discrete time steps of the continuous physical system of FIG. 1E and an illustration of how a wave disturbance propagates within the domain.

FIG. 1G is a schematic diagram illustrating a model of a physical system that simulates a wave propagation domain.

FIG. 2A shows raw audio waveforms of spoken vowel samples from three classes used to train a simulation of a continuous physical system.

FIG. 2B is a schematic diagram of a layout of a continuous physical system used for vowel recognition.

FIG. 2C shows three graphs of measured time-integrated power at each of three probes in response to input signals representing three different vowel classes.

FIG. 2D shows a sequence of material density distributions as sequentially updated during training using gradient-based stochastic optimization techniques.

FIG. 3A and FIG. 3B are the confusion matrices over the training and testing datasets, respectively, for the initial material density distribution prior to training.

FIG. 3C and FIG. 3D are the confusion matrices over the training and testing datasets, respectively, for the final material density distribution after completion of training.

FIG. 3E and FIG. 3F show the cross entropy loss value and the prediction accuracy, respectively, as a function of the training epoch over the testing and training datasets FIG. 3G, FIG. 3H, and (FIG. 3I) are plots of the time-integrated intensity distribution for inputs representing the ae, ei, and iy vowel classes, respectively.

FIG. 4 is a graph of the frequency content of the three vowel classes in the training set after downsampling to 10 kHz.

### DETAILED DESCRIPTION OF THE INVENTION

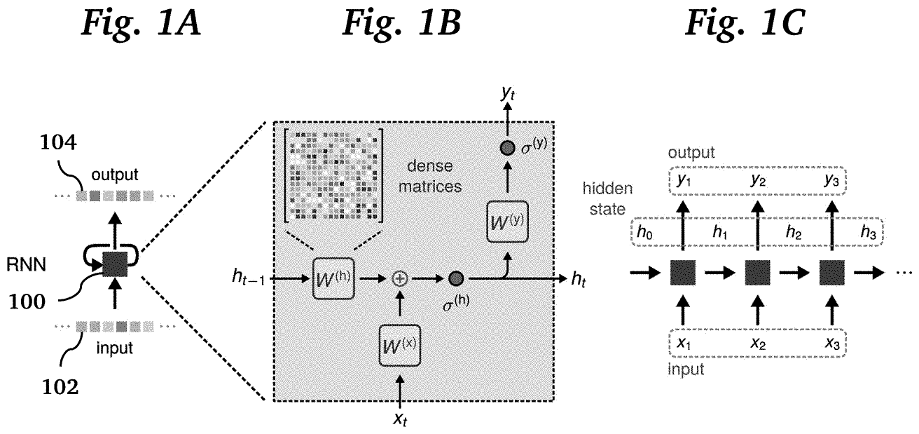

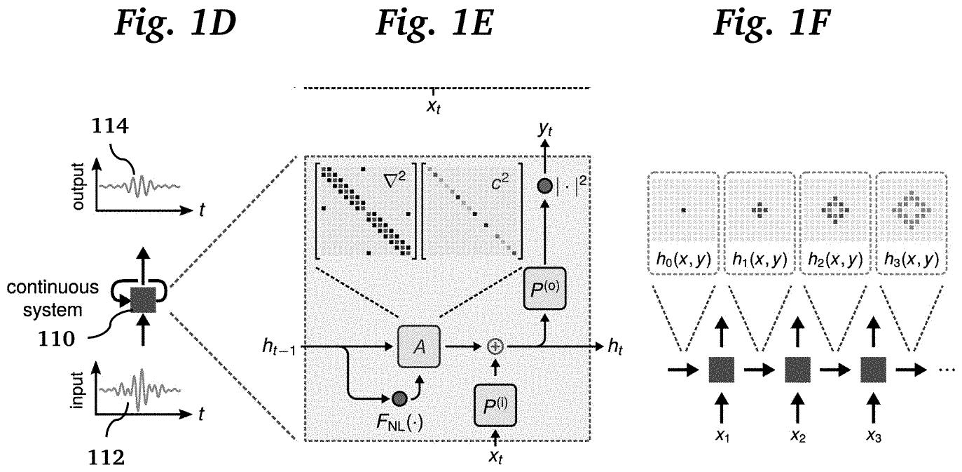

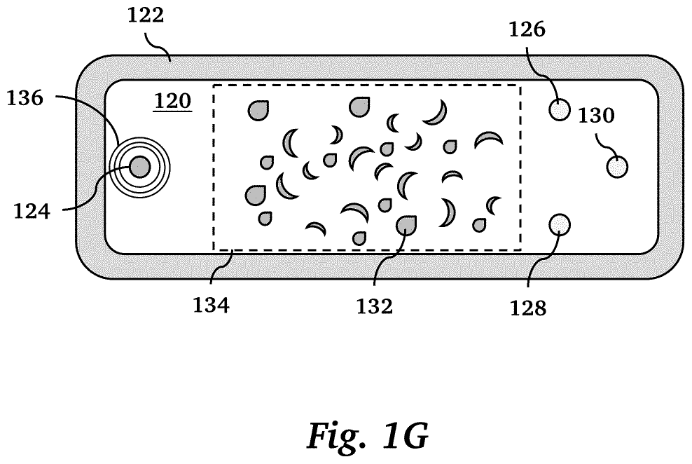

Underlying the techniques of the present invention is an insight into the formal correspondence between the dynamics of wave-based physical systems and the computation in recurrent neural networks (RNNs). This correspondence will now be described in relation to FIGS. 1A-F.

FIG. 1A is a diagram of a recurrent neural network (RNN) cell 100 operating on a discrete input sequence 102 and producing a discrete output sequence 104. The RNN cell 100 applies the same basic operation to each member of the input sequence 102 in a step-by-step process to convert the sequence of inputs into the sequence of outputs 104.

FIG. 1B shows the internal components of the RNN cell 100 of FIG. 1A. At a given time step, t, the RNN operates on the current input vector in the sequence, xₜ, and the hidden state vector from the previous step, hₜ₋₁, to produce an output vector, yₜ, as well as an updated hidden state, hₜ. Memory of previous time steps is encoded into the RNN cell's hidden state, which is updated at each step. The hidden state allows the RNN to retain memory of past information and to learn temporal structure and long-range dependencies in data. The RNN includes trainable dense matrices W^{(h)}, W^{(x)}, and W^{(Y)}. Activation functions for the hidden state and output are represented by σ^{(h)} and σ^{(y)}, respectively. While many variations of RNNs exist, a common implementation is described by the following update equations

hₜ=σ^{(h)}(W^{(h)}·hₜ₋₁+W^{(x)}·xₜ) (1)

yₜ=σ^{(y)}(W^{(y)}·hₜ), (2)

which are represented diagrammatically in FIG. 1B. This RNN structure is simulated com-putationally, and the dense matrices defined by W^{(h)}, W^{(x)}, and W^{(Y)} are optimized during training while σ^{(h)}(·) and σ^{(y)}(·) are nonlinear activation functions.

The operation prescribed by Eq. 1 and Eq. 2, when applied to each element of an input sequence, can be described by the directed graph shown in FIG. 1C. In the first step, input vector x₁ is processed by the cell using hidden state h₀ to produce output vector y₁ and updated hidden state h₁. In the second step, input vector x₂ is processed by the cell using hidden state h₁ to produce output vector y₂ and updated hidden state h₂. In the third step, input vector x₃ is processed by the cell using hidden state h₂ to produce output vector y₃ and updated hidden state h₃, and so on.

We now discuss the formal correspondence between the dynamics in the RNN as described by Eq. 1 and Eq. 2, and the dynamics of a wave-based physical system. FIG. 1D is a recurrent representation of a continuous wave-based physical system that is analogous to the recurrent neural network (RNN) cell of FIG. 1A. Similar to how cell 100 in FIG. 1A operates on a discrete input sequence 102 to produce a discrete output sequence 104, a continuous physical system 110 in FIG. 1D operates on a continuous input signal 112 to produce a continuous output signal 114.

As an illustration, the dynamics of a scalar wave field distribution u(x, y, z) are governed by the second-order partial differential equation,

$$\frac{{\partial }^{2} u}{\partial {t}^{2}} - {c}^{2} \cdot {∇}^{2} u = f , \qquad ( 3 )$$

where

$${∇}^{2} = \frac{{\partial }^{2}}{\partial {x}^{2}} + \frac{{\partial }^{2}}{\partial {y}^{2}} + \frac{{\partial }^{2}}{\partial {z}^{2}}$$

is the Laplacian operator, c=c(x, y, z) is the spatial distribution of the wave speed, and ƒ=ƒ(x, y, z, t) is a source term.

To make the correspondence with the RNN more exact, the continuous physical system is represented in discrete time. A finite-difference discretization of Eq. 3, with a temporal step size of Δt, results in the recurrence relation,

$$\frac{{u}_{t + 1} - 2 {u}_{t} + {u}_{t - 1}}{Δ {t}^{2}} - {c}^{2} \cdot {∇}^{2} {u}_{t} = {f}_{t} . \qquad ( 4 )$$

Here, the subscript, t, indicates the value of the scalar field at a fixed time step. The wave system's hidden state is defined as the concatenation of the field distributions at the current and immediately preceding time steps, hₜ≡[uₜ, uₜ₋₁]^{T}, where uₜ and uₜ₋₁ are vectors given by the flattened fields, uₜ and uₜ₋₁, represented on a discretized grid over the spatial domain. Then, the update of the wave equation may be written as

hₜ=A(hₜ₋₁)·hₜ₋₁+P⁽ⁱ⁾−xₜ (5)

yₜ=(P^{(o)}·hₜ)², (6)

where xₜ and yₜ describe the input signal and output signal, respectively, of the wave equation, where the sparse matrix A describes the update of the wave fields uₜ and uₜ₋₁ without a source, and where P⁽ⁱ⁾ and P^{(o)} are linear operators that describe connections between the hidden state and the input and output of the wave equation. These discretized dynamics are represented diagrammatically in FIG. 1E, which shows the recurrence relation for the wave equation when discretized using finite differences. This structure is analogous to the RNN cell structure shown in FIG. 1B.

For sufficiently large field strengths, the dependence of A on hₜ₋₁ can be achieved through an intensity-dependent wave speed of the form c=cₗᵢₙ+uₜ²·cₙₗ, where cₙₗ is exhibited in regions of material with a nonlinear response. In practice, this form of nonlinearity is encountered in a wide variety of wave physics, including shallow water waves, nonlinear optical materials via the Kerr effect, and acoustically in bubbly fluids and soft materials. Like the σ^{(y)}(·) activation function in the standard RNN, a nonlinear relationship between the hidden state, hₜ, and the output, yₜ, of the wave equation is typical in wave physics when the output corresponds to a wave intensity measurement, as we assume here for Eq. 6.

Like the standard RNN, the connections between the hidden state hₜ and the input and output xₜ and yₜ are also defined by linear operators, given by P⁽ⁱ⁾ and P^{(o)}. These matrices define the injection and measuring points within the spatial domain. Unlike the standard RNN, where the input and output matrices are dense, the input and output matrices of the wave equation are sparse because they are non-zero only at the location of injection and measurement points. Moreover, these matrices are unchanged by the training process.

Most importantly, the trainable free parameter of the wave equation is the distribution of the wave speed, c(x, y, z). In practical terms, this corresponds to the physical configuration and layout of materials within the domain that influence wave propagation. Thus, when modeled numerically in discrete time as represented in FIG. 1E, the wave equation defines an operation which corresponds to that of an RNN as represented in FIG. 1B.

Similarly to the RNN, the full time dynamics of the wave equation may be represented as a directed graph of discrete time steps of the continuous physical system, as shown in FIG. 1F. A sequence of discrete-time inputs x₁, x₂, x₃ is processed by the system in accordance with a sequence of hidden states h₀(x, y), h₁(x, y), h₂(x, y), h₃(x, y) to produce a sequence of corresponding discrete-time outputs y₁, y₂, y₃, where x, y refer to the spatial coordinates of the device. In contrast with the RNN case, here the nearest-neighbor coupling enforced by the Laplacian operator leads to information propagating through the hidden state with a finite velocity. FIG. 1F also illustrates with the sequence of grids how a wave disturbance propagates within the domain.

Based on the formal correspondence between the dynamics of wave-based physical systems and the computation in recurrent neural networks (RNNs), an analog computer that implements a trained recurrent neural network can be designed as follows.

A wave-based physical system, which for example may be an acoustic, hydraulic, or optical system, is simulated using a computational simulation such as a machine learning computing platform. As illustrated in FIG. 1G, the simulation includes a model of the physical system that simulates a wave propagation domain 120, an absorbing or reflecting boundary layer 122 that approximates an open or closed boundary condition, a source of waves 124 located in the wave propagation domain, one or more localized or spatially extended probes 126, 128, 130 in the wave propagation domain for measuring properties of propagated waves such as field amplitude or time-integrated power, and a material 132 that is distributed within a central region 134 of the wave propagation domain and is capable of altering the propagation of the waves. The simulation also includes a discretized numerical model of a differential equation describing dynamics of the propagation of waves in the physical system. Specifically, this numerical model describes the propagation of waves 136 originating at source 124 and propagating under the influence of material 132 and boundary layer 122 to probes 126, 128, 130 which measure amplitude or power of the propagated waves.

This simulation is trained with sequential training data to minimize a loss function with respect to physical characteristics of the material 132 that is distributed within a central region 134 of the simulation domain using gradient-based optimization. The trained physical characteristics of the material may be, for example, a material density distribution of the material. The training is performed by inputing training samples of the training data at the source 124 in batches, computing for each batch measured properties of propagated waves at the probes 126, 128, 130, and evaluating for each batch the loss function between the measured properties of propagated waves at the probes and a correct classification of each sample in the training data.

As a concrete illustrative example, we now describe how an inverse-designed inhomo-geneous medium can perform vowel classification on raw audio signals as their waveforms scatter and propagate through it, achieving performance comparable to a standard digital implementation of a recurrent neural network.

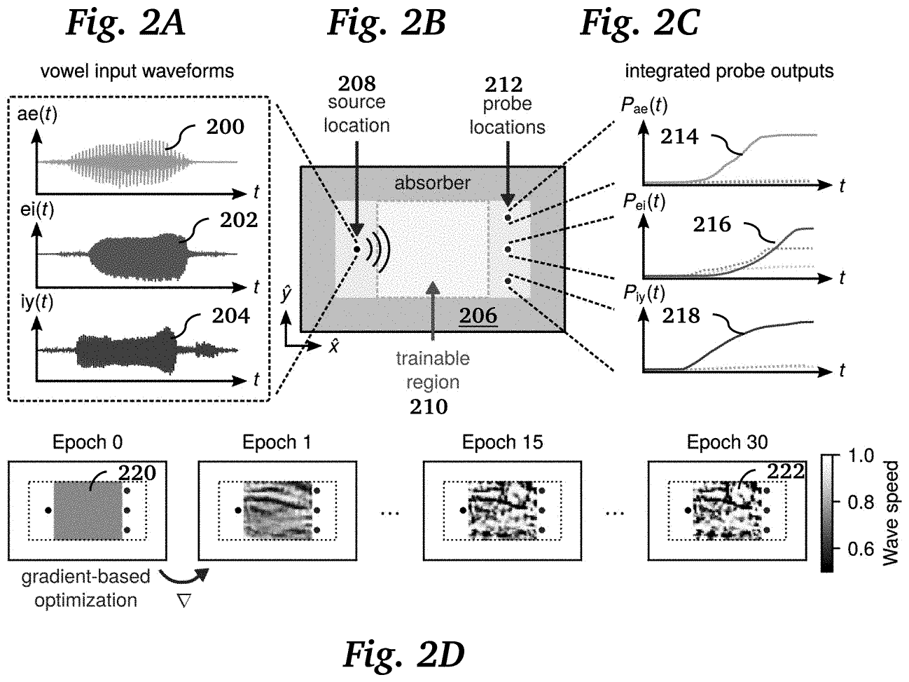

The analog computer is designed by simulating the physical system and training its inho-mogeneous material distribution so that the propagation through the distribution of audio signals input into the system results in distinct classifying signals at the probes depending on the input vowel. The training in this illustrative example uses a training dataset consisting of 930 raw audio recordings of 10 vowel classes from 45 different male speakers and 48 different female speakers. For the learning task, we select a subset of 279 recordings corresponding to three vowel classes contained in the words had, hayed, and heed, respectively. FIG. 2A shows the raw audio waveforms of spoken vowel samples from the three vowel classes: the vowel sounds ae 200, ei 202, and iy 204.

The procedure for training the vowel recognition system is as follows. First, each vowel waveform is downsampled from its original recording, with a 16 kHz sampling rate, to a sampling rate of 10 kHz. Next, the entire dataset of (3 classes)×(45 males+48 females)=279 vowel samples is divided into 5 groups of approximately equal size.

Cross validated training is performed with 4 out of the 5 sample groups forming a training set and 1 out of the 5 sample groups forming a testing set. Independent training runs are performed with each of the 5 groups serving as the testing set, and the metrics are averaged over all training runs. Each training run is performed for 30 epochs using the Adam optimization algorithm with a learning rate of 0.0004. During each epoch, every sample vowel sequence from the training set is windowed to a length of 1000, taken from the center of the sequence. This limits the computational cost of the training procedure by reducing the length of the time through which gradients must be tracked.

All windowed samples from the training set are run through the simulation in batches of 9 and the categorical cross entropy loss is computed between the output probe probability distribution and the correct one-hot vector for each vowel sample. To encourage the optimizer to produce a binarized distribution of the wave speed with relatively large feature sizes, the optimizer minimizes this loss function with respect to a material density distribution, p(x, y) within a central region of the simulation domain, indicated by the green region in FIG. 2B. The distribution of the wave speed, c(x, y), is computed by first applying a low-pass spatial filter and then a projection operation to the density distribution. The details of this process are described in supplementary materials section 5. FIG. 2D illustrates the optimization process over several epochs, during which, the wave velocity distribution converges to a final structure. At the end of each epoch, the classification accuracy is computed over both the testing and training set. Unlike the training set, the full length of each vowel sample from the testing set is used.

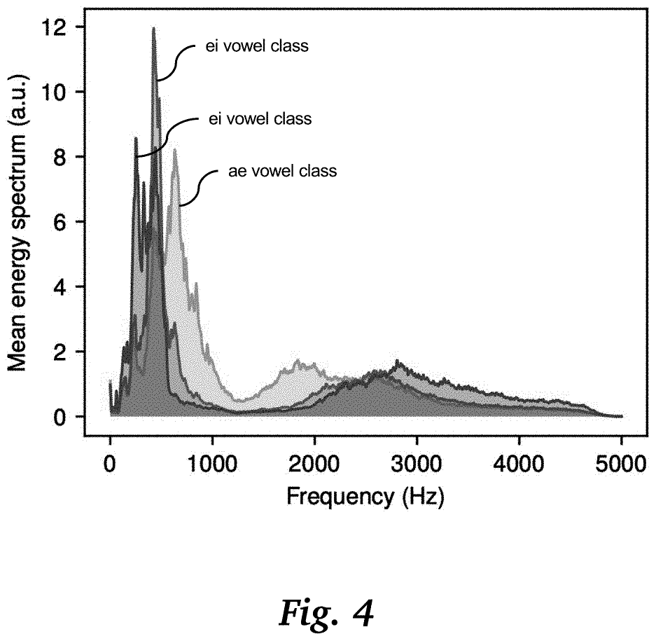

The frequency content of the three vowel classes after downsampling to 10 kHz is shown in FIG. 4. The plotted quantity is the mean energy spectrum for the ae, ei, and iy vowel classes. We observe that the majority of the energy for all vowel classes is below 1 kHz and that there is strong overlap between the mean peak energy of the ei and iy vowel classes. Moreover, the mean peak energy of the ae vowel class is very close to the peak energy of the other two vowels. Therefore, the vowel recognition task learned by the system is non-trivial.

As shown in FIG. 2B, the physical layout of the vowel recognition system includes an absorber 206 defining a boundary of a two-dimensional wave propagation domain in the x-y plane, infinitely extended along the z-direction. The absorbing boundary region prevents energy from building up inside the computational domain. The domain includes a source 208 where input signals are independently injected, a trainable region 210 containing a distribution of material, and probes 212 that measure output signals, i.e., properties of the waves incident at the probes after having propagated through the trainable region whose material interacts with the propagating waves originating from the source.

The audio waveform of each vowel, represented by x⁽ⁱ⁾, is injected by the source 208 at a single grid cell on the left side of the domain, emitting waveforms which propagate through a trainable region 210 with a distribution of the wave speed that is optimized during the training process. Three probe points 212 are defined on the right hand side of this region, each assigned to one of the three vowel classes. To determine the system's output, y⁽ⁱ⁾, the time-integrated power at each probe is measured. FIG. 2C shows three graphs 214, 216, 218 of the time-integrated power measured at each probe and corresponding to the three input vowel sound waveforms 200, 202, 204 shown in FIG. 2A. After the simulation evolves for the full duration of the vowel recording, this integral gives a non-negative vector of length 3, which is then normalized by its sum and interpreted as the system's predicted probability distribution over the vowel classes.

Using automatic differentiation, the gradient of the loss function with respect to the density of material in the trainable region 210 is computed. The material density is updated iteratively, using gradient-based stochastic optimization techniques, until convergence. For the illustrative purposes of this numerical demonstration, we consider binarized systems made of two materials: a background material with a normalized wave speed c₀=1.0, and a second material with c₁=0.5. We assume that the second material has a nonlinear parameter, cₙₗ=−30, while the background material has a linear response. In practice, the wave speeds would be selected to correspond to different materials to be used in the physical realization of the design. For example, in an acoustic setting the material distribution could consist of air, where the sound speed is 331 m/s, and porous silicone rubber, where the sound speed is 150 m/s.

At the beginning of the training, the initial distribution of the wave speed may be selected to correspond to a uniform region of material with a speed which is midway between those of the two materials. This choice of starting structure allows for the optimizer to shift the density of each pixel towards either one of the two materials to produce a binarized structure made of only those two materials. To train the system, we perform back-propagation through the model of the wave equation to compute the gradient of the cross entropy loss function of the measured outputs with respect to the density of material in each pixel of the trainable region. Then, we use this gradient information update the material density using the Adam optimization algorithm, repeating until convergence on a final structure. FIG. 2D illustrates a sequence of distributions of the trainable region 210 during the training process, starting with the initial uniform distribution 220 and ending with the final distribution 222 of material in the design to be used in the physical realization of the analog computer implementing the RNN.

Numerical modeling and simulation of the wave equation physics was performed using a custom package written in Python. The software was developed on top of the popular machine learning library, pytorch, to compute the gradients of the loss function with respect to the material distribution via reverse-mode automatic differentiation. In the context of inverse design in the fields of physics and engineering, this method of gradient computation is commonly referred to as the adjoint variable method and has a computational cost of performing one additional simulation. We note that related approaches to numerical modeling using machine learning frameworks have been proposed previously for full-wave inversion of seismic datasets. The code for performing numerical simulations and training of the wave equation, as well as generating the figures presented in this description, may be found online at http://www.github.com/fancompute/wavetorch/.

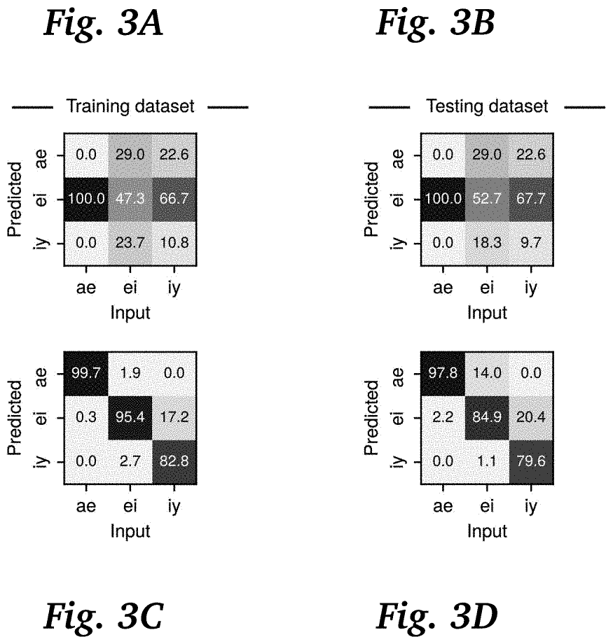

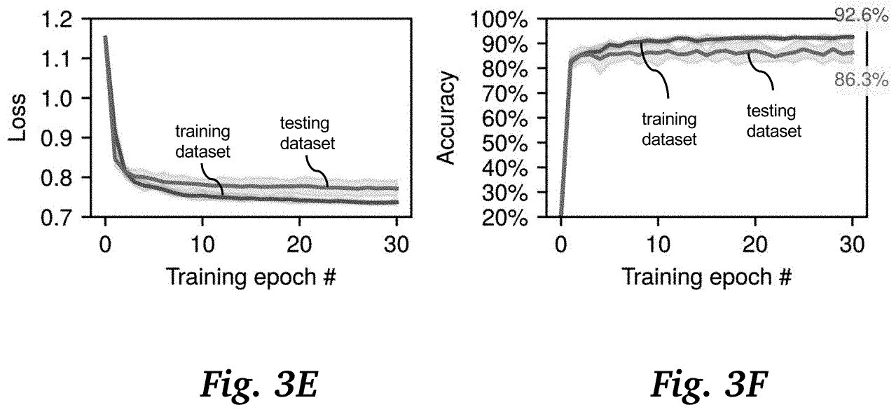

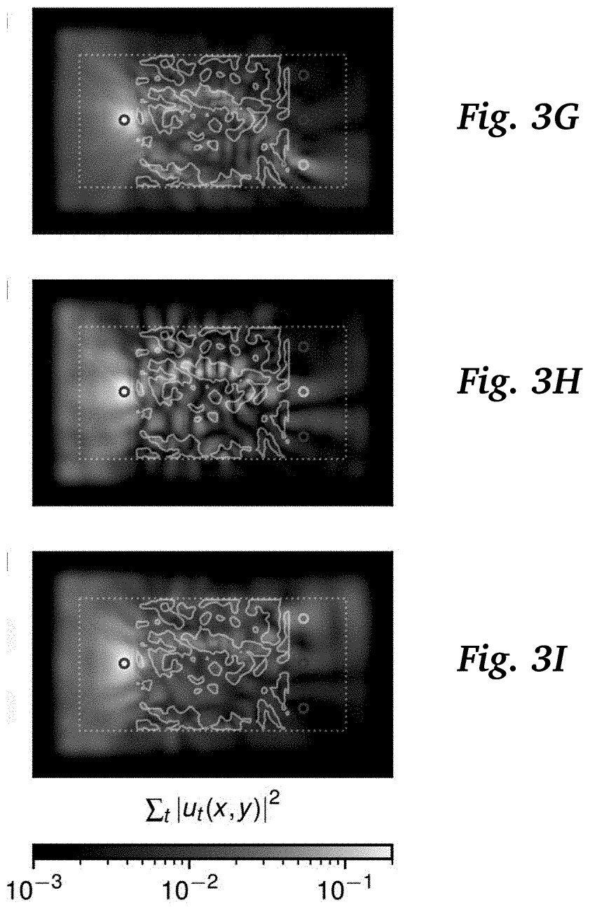

We now discuss vowel recognition training results in relation to FIGS. 3A-I. The confusion matrices over the training and testing sets for the starting structure are shown in FIG. 3A and FIG. 3B, averaged over five cross-validated training runs. Here, the confusion matrix indicates the percentage of correctly predicted vowels along its diagonal entries and the percentage of incorrectly predicted vowels for each class in its off-diagonal entries. Clearly, the starting structure cannot perform the recognition task. FIG. 3C and FIG. 3D show the final confusion matrices after optimization for the testing and training sets, averaged over five cross validated training runs. The trained confusion matrices are diagonally dominant, indicating that the structure can indeed perform vowel recognition. From FIG. 3C and FIG. 3D we observe that the system attains near perfect prediction performance on the ae vowel and is able to differentiate the iy vowel from the ei vowel, but with less accuracy, especially in unseen samples from the testing dataset.

FIG. 3E and FIG. 3F show the cross entropy loss value and the prediction accuracy, respectively, as a function of the training epoch over the testing and training datasets, where the solid line indicates the mean and the shaded region corresponds to the standard deviation over the cross-validated training runs over 30 training epochs and 5 folds of the dataset, which consists of a total of 279 total vowel samples of male and female speakers. Interestingly, we observe that the first epoch results in the largest reduction of the loss function and the largest gain in prediction accuracy. From FIG. 3F we see that the system obtains a mean accuracy of 92.6%±1.1% over the training dataset and a mean accuracy of 86.3%±4.3% over the testing dataset.

FIG. 3G, FIG. 3H, and FIG. 3I show the distribution of the time-integrated field intensity, Σₜuₜ² produced when the source is injected with a representative sample from each vowel class ae vowel, ei vowel, and iy vowel, respectively. We thus provide visual confirmation that the optimization procedure produces a structure which routes the majority of the signal energy to the correct probe. As a performance benchmark, a conventional RNN was trained on the same task, achieving comparable classification accuracy to that of the wave equation. However, a larger number of free parameters was required. Additionally, we observed that a comparable classification accuracy was obtained when training a linear wave equation.

The techniques presented here have a number of favorable qualities that make it a promising candidate for designing analog computers for processing temporally-encoded information. Unlike the standard RNN, the update of the wave equation from one time step to the next enforces a nearest-neighbor coupling between elements of the hidden state through the Laplacian operator, which is represented by the sparse matrix in FIG. 1E. This nearest neighbor coupling is a direct consequence of the fact that the wave equation is a hyperbolic partial differential equation in which information propagates with a finite velocity. Thus, the size of the analog RNN's hidden state, and therefore its memory capacity, is directly determined by the size of the propagation medium. Additionally, unlike the conventional RNN, the wave equation enforces an energy conservation constraint, preventing unbounded growth of the norm of the hidden state and the output signal. In contrast, the unconstrained dense matrices defining the update relationship of the standard RNN lead to vanishing and exploding gradients, which can pose a major challenge for training traditional RNNs.

We have shown that the dynamics of the wave equation are conceptually equivalent to those of a recurrent neural network. This conceptual connection opens up the opportunity for a new class of analog hardware platform, in which evolving time dynamics play a significant role in both the physics and the dataset. While we have focused on a the most general example of wave dynamics, characterized by a scalar wave equation, our results can be readily extended to other wave-like physics. Such an approach of using physics to perform computation is envisioned to provide a new platform for analog machine learning devices that can perform computation far more naturally and efficiently than their digital counterparts. The generality of the approach implies that many physical systems can be used for performing RNN-like computations on dynamic signals, such as those in optics, acoustics, or seismics.

Those skilled in the art will recognize in light of the present description of the invention and examples give that there are many possible variations. For example, the inventors envision that with minor modifications to the example discussed above closed boundary conditions may be used instead of open boundary conditions. From a simulation and training perspective, the change would simply require removing the absorbing layer, which can be done by modifying the loss coefficient for the wave propagation outside of the central design region. From a physical perspective, using a reflective/closed boundary condition would mean that the injected signal bounces around the system far more readily. From some point of view, this might help the training process because the system can have greater ‘memory’ of input signals from earlier time steps. From another perspective, this could hurt training because much of this signal may be irrelevant to the training task. In some sense, we believe that the choice of boundary condition or presence of loss, more generally, is an engineering problem that can be explored in future studies and applications, but there are arguments for both approaches, or a hybrid approach.

The inventors also envision that with minor modifications the model output probes may be extended probe regions measuring various properties of the waves. In the example discussed above, the output of the model was a vector of length 3 where each element was related to the probability of this audio signal being from one of three vowels. One can instead use many other more complicated models. For example, we could consider a model where the output is, instead, a 2 dimensional image, where the wave power at each point in the device is related to the brightness of the image as a function of x and y. This would be one example of a spatially extended probe region.

Furthermore, while we chose to integrate our signal power over time (giving a single number for each probe output), we could rather use the time-dependent power measurement (P(t) at each probe) as our output. For example, we could input a time signal I(t) into our analog processor and measure the power over time at a receiver P(t), which would be some kind of nonlinear filter I(t)→P(t). As a concrete application, we could input audio from a male voice as I(t) and have the model output a female-sounding voice as P(t).

1. A method of designing an analog computer that implements a trained recurrent neural network, the method comprising:
(a) simulating a wave-based physical system using a computational simulation, wherein the computational simulation comprises:
i. a wave propagation domain,
ii. a boundary layer that approximates a boundary condition,
iii. a source of waves, probes for measuring properties of propagated waves,
iv. a material within a central region of the wave propagation domain, and
v. a discretized numerical model of a differential equation describing dynamics of wave propagation in the physical system;
(b) training the simulation with sequential training data, wherein the training comprises:
i. inputing samples of the training data at the source in batches,
ii. computing for each batch measured properties of propagated waves at the probes,
iii. evaluating for each batch a loss function between the measured properties of propagated waves at the probes and correct classification, and
iv. minimizing the loss function with respect to physical characteristics of the material within a central region of the simulation domain using gradient-based optimization.

2. The method of claim 1 wherein the physical characteristics comprise a material density distribution of the material within a central region of the simulation domain.

3. The method of claim 1 wherein the simulating comprises a low-pass spatial filtering applied to a wave speed distribution to implement training regularization.

4. The method of claim 1 wherein the simulating and training are implemented using a machine learning computing platform.

5. The method of claim 1 wherein the wave-based physical system is an acoustic, hydraulic, or optical system.

6. The method of claim 1 wherein the boundary layer is an absorbing boundary layer and the boundary condition is an open boundary condition.

7. The method of claim 1 wherein the boundary layer is a reflecting boundary layer and the boundary condition is a closed boundary condition.

8. The method of claim 1 wherein the probes for measuring properties of propagated waves are point probes.

9. The method of claim 1 wherein the probes for measuring properties of propagated waves are spatially extended probes.

10. The method of claim 1 wherein the measured properties of propagated waves comprise time-integrated power or field amplitude.
